(19) United States
(12) Patent Application Publication
(10) Pub. No.: US 2009/0303332 A1
(43) Pub. Date: Dec. 10, 2009

(54) SYSTEM AND METHOD FOR OBTAINING IMAGE OF MAXIMUM CLARITY

(76) Inventor: Heuiwook KIM, Allen, TX (US)

Correspondence Address: TEXAS INSTRUMENTS INCORPORATED, P O BOX 655474, M/S 3999, DALLAS, TX, 75265, US

(21) Appl. No.: 12/133,427

(22) Filed: Jun. 5, 2008

(51) Int. Cl. H04N 5/225

(52) U.S. Cl. 348/208.4; 348/E05.024

(57) ABSTRACT

The present invention provides a system for and method of obtaining a clear picture in the face of shaking or movement of the digital camera or motion of an object under capture. The present invention utilizes the burst mode feature present on conventional digital cameras in which several continuous images of an object are captured. An image processor is operable to process the image data using a compression technique based on a spatial frequency transformation, for example JPEG. For images processed with a JPEG compression technique, image file size is directly related to the clarity of the image. Therefore, JPEG-compressed data having a large file size corresponds to an image of an object that is clear, whereas JPEG-compressed data having a smaller file size corresponds to an image of the object that is blurry. Therefore, to address the effect of blurring, the present invention includes a selection process in which the largest processed image data file is selected from a set of processed image data files corresponding to images taken in burst mode. The processed image data with the largest file size is stored in memory while the remaining smaller processed image data files are deleted.

### BACKGROUND

Blurring of images is a common complaint among digital camera users. The motion of an object under capture or even the movement of the camera itself can reduce image sharpness and render a promising snapshot unusable. The shaking of a user's hand is a very common source of image blurring. Such images may be considered a nuisance since they lack the detail expected by the user. In some instances, blurring can become so severe, the images are rendered unusable.

Several anti-shaking techniques have been considered to reduce the effects of image blurring. Since cameras with shutter speeds are more vulnerable to image blur, the use of higher ISO has been recommended. ISO denotes is how sensitive the image sensor is to the amount of light present. However, for digital cameras at high ISOs, the amount of visible noise and grain produced by the image sensors reduces the quality of the image, effectively substituting one problem for another.

Anti-blurring technology exists on the market but requires expensive upgrades or complicated processor algorithms. Optical lens stabilizers, for example, require the use of shake-detecting sensors within the digital camera assembly to detect lens movement, a specially programmed image processor to correct the image based on data from the shake detecting sensors, and set of movable lenses which adjust under instruction from the image processor. Digital image stabilizers are used in video cameras and require complicated image processing algorithms to pixel shift digital images between frames. Such devices are expensive solutions to a very common problem.

### BRIEF SUMMARY

The present invention provides a system for and method of obtaining a clear picture in the face of shaking or movement of the digital camera or motion of an object under capture.

The present invention utilizes the burst mode feature present on conventional digital cameras in which several continuous images of an object are captured.

As discussed above, a likelihood exists for blurring of an image for each picture. In a burst mode, a camera takes a plurality of pictures in rapid succession. Because the pictures are taken in rapid succession, the differences in the subject matter in each picture may vary only slightly, depending on the speed of the camera detector. However, differences in shaking or movement of the digital camera or motion of the object under capture between each picture will result in different levels of clarity in the pictures. With this method at least one of the pictures will be the clearest, i.e., have the least blurring.

As with conventional digital cameras, image data is transmitted from the image sensor to the image processor for conversion to a standard file format. One aspect of this invention is an image processor operable to process the image data using a compression technique based on a spatial frequency transformation, for example the technique from the standard Joint Photographic Experts Group (JPEG). For images processed with a JPEG compression technique, image file size is directly related to the clarity of the image. Therefore, JPEG-compressed data having a large file size corresponds to an image of an object that is clear, whereas JPEG-compressed data having a smaller file size corresponds to an image of the object that is blurry. Therefore, to address the effect of blurring, the present invention includes a selection process in which the largest processed image data file is selected from a set of processed image data files corresponding to images taken in burst mode. In one embodiment, the processed image data with the largest file size is stored in memory while the remaining smaller processed image data files are deleted. One exemplary embodiment of this invention deletes the smaller image files automatically, whereas a second embodiment sends all image data files to the memory for later deletion instruction.

In accordance with an aspect of the present invention, a device comprises and image sensor, an image processor and a memory portion. The image sensor is operable to obtain a first image, to produce first image data based on the first image, to obtain a second image and to produce second image data based on the second image. The image processor is in communication with the image sensor. The image processor is operable to receive a first input data based on the first image data, to receive a second input data based on the second image data, to process the first input data into first processed image data having a first feature and to process the second input data into second processed image data having a second feature. The image processor is further operable to perform a comparison of the first feature and the second feature and to obtain a result of the comparison. The image processor is further operable to output at least one of the first processed image data and the second processed image data. The memory portion is operable to store at least one image memory data based on the outputted at least one of the first processed image data and the second processed image data, respectively.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates four images of an object taken in succession from a digital camera;

FIG. 2 illustrates an exemplary imaging device in accordance with the present invention;

FIG. 3 is a logic flow diagram explaining an exemplary serial processing method of operation of the device of FIG. 2;

FIG. 4 is a logic flow diagram explaining an exemplary parallel processing method of operation of the device of FIG. 2; and

FIG. 5 is an oblique view of an exemplary digital camera in accordance with the present invention;

FIG. 6 illustrates another exemplary imaging device in accordance with the present invention;

FIG. 7 is an oblique view of another exemplary digital camera in accordance with the present invention.

### DETAILED DESCRIPTION

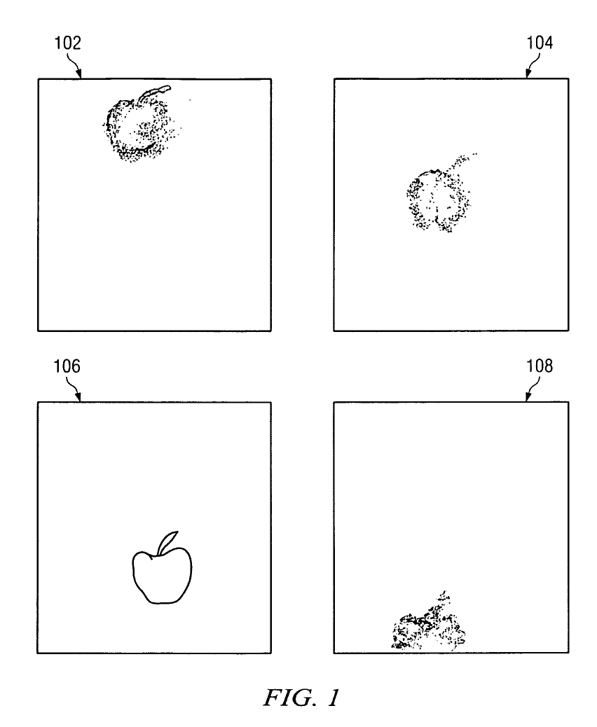

An aspect of the present invention deals with a digital camera having a burst mode, wherein a plurality of images are rapidly taken of a subject. Exemplary embodiments of the present invention will be described in connection with a digital camera operating in a burst mode to obtain consecutive images 102, 104, 106 and 108 of the apple falling as illustrated in FIG. 1. Image 102 is taken at time t₁ of the burst mode, image 104 is taken at time t₂ of the burst mode, image 106 is taken at time t₃ of the burst mode and image 108 is taken at time t₄ of the burst mode. From the figure, one will note that image 106 is the clearest image whereas each of images 102, 104 and 108 has a different amount of blurring. The blurring may be caused by at least one of camera shake or motion of the apple. By using the relationship between a data file size of a JPEG-compressed image and the clarity of the non-compressed corresponding image, the present invention is operable to obtain the clearest image taken in a burst mode of operation of a digital camera.

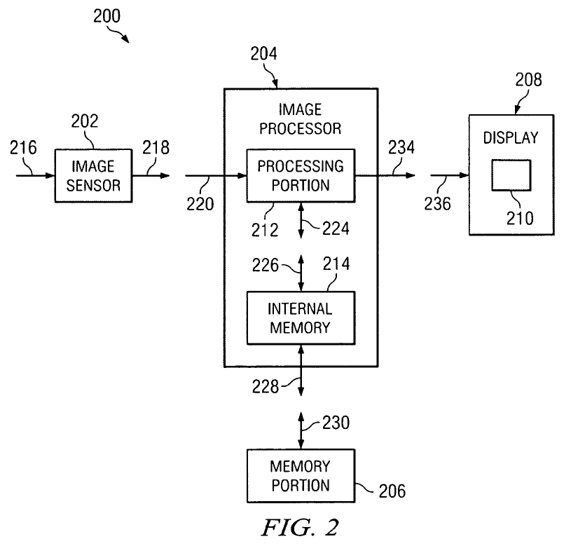

FIG. 2 illustrates an exemplary imaging device 200 in accordance with the present invention. Imaging device 200 includes an image sensor 202, an image processor 204, a memory portion 206 and a display 208. Image processor 204 includes a processing portion 212 and an internal memory 214. Display 208 is operable to display an image 210.

Image sensor 202 is operable to receive image data 216 corresponding to image 102 at time t₁, image 104 at time t₂, image 106 at time t₃ and image 108 at time t₄. Image sensor 202 is further operable to output an image data signal 218, corresponding to image data 216. Image sensor 202 may be any imaging device operable to receive images and output corresponding signals, a non-limiting example of which includes a charge coupled display.

Image processor 204 is operable to receive an input data signal 220, based on image data signal 218. Image processor 204 may directly receive image data signal 218 from image sensor 202, in which case image data signal 218 is input data signal 220. Alternately, intermediate circuitry may be included between image sensor 202 and image processor 204 to modify image data signal 218. Non-limiting examples of intermediate circuitry include matching networks, amplifiers, filters, resistors, etc.

Processing portion 212 receives input data signal 220 and compresses data therein by known compression methods, non-limiting examples of which include spatial frequency transformation methods. In an exemplary working embodiment, processing portion 212 utilizes a JPEG compression method. Compressed data corresponding to image 102 at time t₁, image 104 at time 12, image 106 at time t₃ and image 108 at time t₄ of input data signal 220 are stored in internal memory 214 via an output/input line 224 at processing portion, which is in communication with an input/output line 226 at internal memory 214. Internal memory 214 may directly receive compressed data from processing portion 212, in which case output/input line 224 is input/output line 226. Alternately, intermediate circuitry may be included between output/input line 224 and input/output line 226 to modify the compressed data. Non-limiting examples of intermediate circuitry include matching networks, amplifiers, filters, resistors, etc.

After compressing data, processing portion 212 compares a predetermined feature of compressed data for each of image 102 at time t₁, image 104 at time t₂, image 106 at time t₃ and image 108 at time t₄. In the exemplary working embodiment, processing portion 212 compares the size of the JPEG-compressed data for each of the images. After comparing a feature of compressed data, processing portion 212 chooses the compressed data corresponding to one of images 102, 104, 106 and 108. In the exemplary working embodiment, processing portion 212 chooses the JPEG-compressed data having the largest size, which corresponds to the image having the sharpest image quality. Referring back to FIG. 1, image 106 has the sharpest image quality. Accordingly, in the exemplary working embodiment, the JPEG-compressed data corresponding to image 106 would have the largest size, and would therefore be chosen by processing portion 212. In some embodiments, processing portion 212 is a single element. In other embodiments, processing portion comprises a plurality of processing elements, each operable to provide a separate processing function. In one embodiment, processing portion 212 includes two separate processing elements: a first element operable to provide a compression processing function; and a second element operable to provide a decompressing function.

After choosing the compressed data based on the predetermined feature, image processor 204 instructs internal memory 214 to store a copy of the compressed data in memory portion 206. In an exemplary embodiment, referring back to FIG. 1, the compressed data to be stored in memory portion 206 corresponds to the JPEG-compressed data corresponding to image 106. Internal memory therefore copies the chosen compressed data to memory portion 206 via output/input line 228 of internal memory to input/output line 230 of memory portion 206. Input/output line 230 may directly receive compressed data from output/input line 228, in which case input/output line 230 is output/input line 228. Alternately, intermediate circuitry may be included between input/output line 230 and output/input line 228 to modify the compressed data. Non-limiting examples of intermediate circuitry include matching networks, amplifiers, filters, resistors, etc.

In addition to instructing internal memory 214 to store the chosen compressed data in memory portion 206, processing portion additional retrieves a copy of the chosen compressed data for decompression. After decompressing the chosen decompressed data, processing portion 212 outputs the decompressed data as a selected image output 234. Display 208 receives data 236 based on selected image output 234. Display 208 may directly receive selected image output 234 from processing portion 212, in which data 236 is selected image output 234. Alternately, intermediate circuitry may be included between display 208 and processing portion 212 to modify the selected image output 234. Non-limiting examples of intermediate circuitry include matching networks, amplifiers, filters, resistors, etc.

Display 208 then displays an image 210 corresponding to data 236. In the exemplary embodiment, and referring back to FIG. 1, image 210 corresponds to image 106, the clearest image.

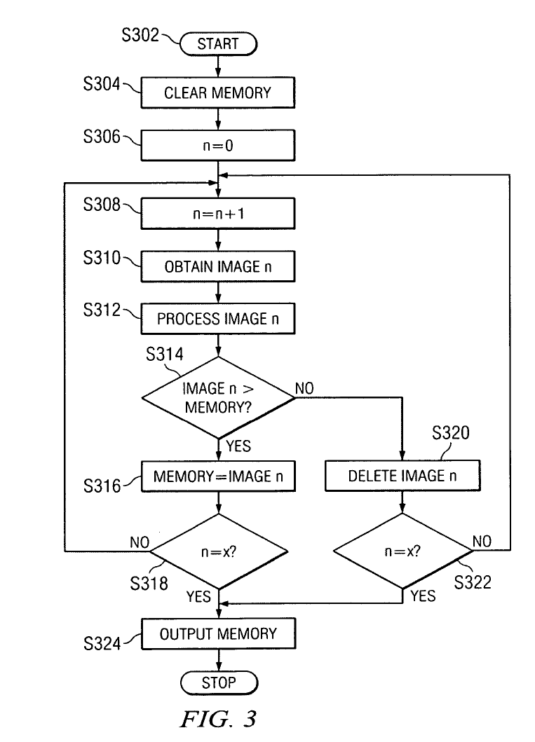

FIG. 3 illustrates an exemplary process by which a burst of images are received, processed, and selected with an imaging system in accordance with an aspect of the present invention. The process is initiated with step S302 after which the user clears internal memory portion 214 (step S304). Non-limiting methods of performing this step include an automatic memory clear when turning on the camera or pushing a dedicated memory clear button. Next, a variable n is initially set to zero (S306), and is then set to “n+1” (S308). First image 102 is captured, e.g., received by image sensor 202 (S310). Image data signal is transmitted by image sensor 202 and input data signal 220 is received by image processor 204. Processing portion 212 compresses the data in input data signal for first image 102 (S312). It is then determined whether the compressed data of first image 102 has a large size than the data in internal memory portion 214 (S314). Since memory portion 214 was initially cleared in step S304, then the compressed data has a larger data size. Accordingly, the compressed data corresponding to first image 102 is set in internal memory portion 214 (S316).

It is then determined whether the number of the image n is equal to a predetermined number x (S318). In the exemplary working embodiment, x is the predetermined burst number of images that the camera will take. In some embodiments, the burst number of images is fixed, whereas in other embodiments, the burst number is selectable by the user. In the exemplary working embodiment, x is equal to “4.” For first image 102, n is equal to “1”, which is less than “4.” As such, the process returns to step S308 to increase n to “2.”

Second image 104 is captured, e.g., received by image sensor 202 (S310). Image data signal is transmitted by image sensor 202 and input data signal 220 is received by image processor 204. Processing portion 212 compresses the data in input data signal for second image 104 (S312). It is then determined whether the compressed data of second image 104 has a larger size than the data in internal memory portion 214 (S314). In this case, first image 102 is a little clearer than second image 104. Therefore, the compressed data corresponding to first image 102 is larger than the compressed data corresponding to second image 104. As such, the compressed data corresponding to second image 104 deleted (S320).

Again, it is then determined whether the number of the image n is equal to predetermined number x (S318). For second image 104, n is equal to “2”, which is less than “4.” As such, the process returns to step S308 to increase n to “3.”

Third image 106 is captured, e.g., received by image sensor 202 (S310). Image data signal is transmitted by image sensor 202 and input data signal 220 is received by image processor 204. Processing portion 212 compresses the data in input data signal for third image 106 (S312). It is then determined whether the compressed data of third image 106 has a larger size than the data in internal memory portion 214 (S314). In this case, third image 106 is a much clearer than first image 104. Therefore, the compressed data corresponding to third image 106 is larger than the compressed data corresponding to first image 102. As such, the compressed data corresponding to first image 102 deleted (S320).

Again, it is then determined whether the number of the image n is equal to predetermined number x (S318). For third image 106, n is equal to “3”, which is less than “4.” As such, the process returns to step S308 to increase n to “4.”

Fourth image 108 is captured, e.g., received by image sensor 202 (S310). Image data signal is transmitted by image sensor 202 and input data signal 220 is received by image processor 204. Processing portion 212 compresses the data in input data signal for fourth image 108 (S312). It is then determined whether the compressed data of fourth image 108 has a larger size than the data in internal memory portion 214 (S314). In this case, third image 106 is a much clearer than fourth image 108. Therefore, the compressed data corresponding to third image 106 is larger than the compressed data corresponding to fourth image 108. As such, the compressed data corresponding to fourth image 108 deleted (S320).

Again, it is then determined whether the number of the image n is equal to predetermined number x (S318). For fourth image 108, n is equal to “4”, which is equal to “4.” As such, the process outputs the data in internal memory portion 214 for decompression by processing portion 212 (S324). The decompressed data is then output as a selected image output 234.

In the embodiment discussed above, the camera takes a burst of four images. Of course any number of images may be taken in the burst, subject only to design constraints such as memory size and processing speed.

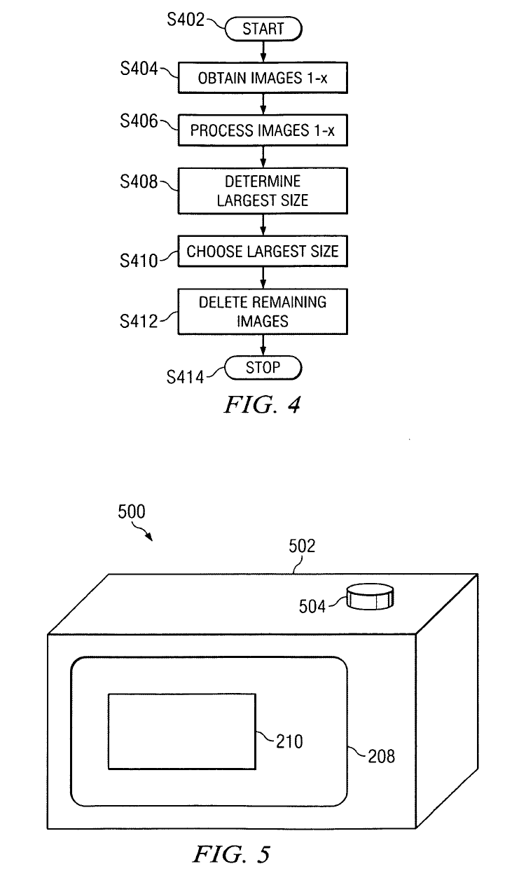

Further, in the embodiment discussed above with respect to FIG. 3, the clearest image is obtained by processing the images serially. In other embodiments, the images may be processed in a parallel manner. An exemplary method of obtaining the clearest image by processing images 102, 104, 106 and 108 in a parallel manner in accordance with the present invention will now be described with reference to the logic flow diagram of FIG. 4.

As illustrated in the figure, once the process starts (S402), images 102, 104, 106 and 108 are captured, e.g., received by image sensor 202 and image data signal 218 is transmitted by image sensor 202 and input data signal 220 is received by image processor 204 (S404). Here, image data signal 218 and input data signal 220 include a serial stream of data corresponding to all of images 102, 104, 106 and 108.

In an exemplary parallel embodiment that may correspond to FIG. 2, processing portion 212 is operable to parallel process data corresponding to all of images 102, 104, 106 and 108 to obtain compressed data for each (S406). With such parallel processing, processing portion 212 is immediately able to determine which compressed data has the largest size (S408). The compressed data having the largest size is then chosen for output as selected image output 234 (S410), the remaining data corresponding to the remaining images are deleted (S412) and the process stops (S414).

In another embodiment that may correspond to FIG. 2, step S404 and step S406 are executed for each image. For example, data corresponding to image 102 may be received by image processor 204 (S404) and may then be processed (S406), then data corresponding to image 104 may be received by image processor 204 (S404) and may then be processed (S406), then data corresponding to image 106 may be received by image processor 204 (S404) and may then be processed (S406), and finally data corresponding to image 108 may be received by image processor 204 (S404) and may then be processed (S406).

FIG. 5 is an oblique view of an exemplary digital camera in accordance with the present invention. In the figure, camera 500 includes a body portion 502, a button 504 and a display 208. Button 504 enables pictures to be taken in a burst mode of operation. Display 208 displays image 210, as the clearest image of all the images taken in the burst mode, for the user.

In the embodiments discussed above with reference to FIG. 2: image processor 204 processes the data corresponding to a plurality of images; compares the processed data with respect to a predetermined feature; chooses one of the processed data based on the comparison; and sends data to display 208 to display image 210 based on the chosen processed data. In the exemplary working embodiment; a camera takes a burst of pictures of an object, wherein image sensor 202 obtains a plurality of images; image data corresponding to the plurality of images are sent to image processor 204 for compression with a JPEG compressing method; the compressed image data are stored in internal memory 214; the size of each compressed image data are compared to determine which compressed image data is the largest; once determined, the largest image data is decompressed and sent to display 208 for display as image 210. Because of the direct relationship between image clarity and JPEG compressed data size, the compressed image data having the largest size will correspond to the image having the best clarity.

In other embodiments, processing portion 212 may automatically instruct either one of internal memory 214 or memory portion 206 to delete the data corresponding to the remaining images. Specifically, as the image having the most clarity will have been determined based on the JPEG-compressed data size, the remaining images will have less clarity and would therefore not likely be needed or wanted. Therefore in order to save valuable space in at least one of internal memory 214 and memory portion 206, processing portion may provide a deletion instruction signal to at least one of internal memory 214 and memory portion 206 to delete the data corresponding to the remaining images.

Other embodiments of the present invention do not include display 208. Specifically, an imaging device need not display the image to the user, but may alternatively have a data access port to access the image data from at least one of internal memory 214 or memory portion 206.

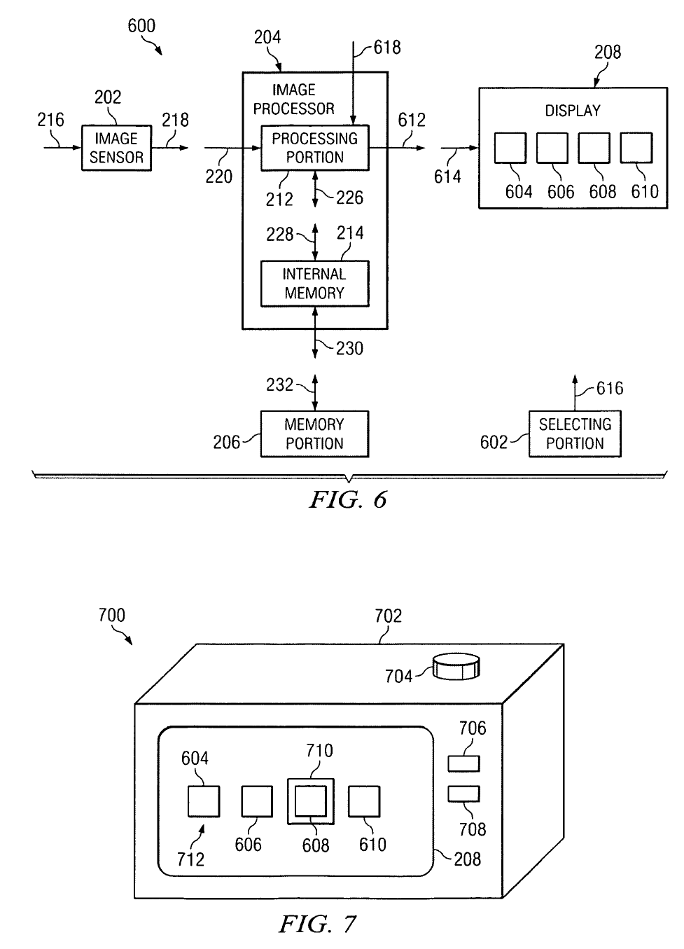

In some instances, although images 102, 104 and 108 may not be as clear as image 106, a user may desire to retain at least one of images 102, 104 and 108. Accordingly, in other embodiments, the user has the option of deleting the data corresponding to the remaining images. Such an embodiment will now be described with respect to FIG. 6.

FIG. 6 illustrates another exemplary imaging device 600 in accordance with the present invention. Imaging device 600 differs from imaging device 200 of FIG. 2 in that imaging device 600 includes a selecting portion 602. Further, display 208 is operable to display image 604, image 606, image 608 and image 610.

The operation of imaging device 600 additionally differs somewhat from the operation of imaging device 200. In particular, in imaging device 600, internal memory 214 copies all compressed data to memory portion 206 via output/input line 228 of internal memory 214 to input/output line 230 of memory portion 206. Further, processing portion 212 is operable to provide indication data based on the predetermined feature. In the exemplary working embodiment, the indication data indicates which JPEG-compressed data has the largest data size. Processing portion 212 further retrieves a copy of all compressed data for decompression. After decompressing all the decompressed data, processing portion 212 outputs the decompressed data in addition to the indication data as selected images output 612. Display 208 receives data 614 based on selected images output 612. Display 208 may directly receive selected images output 612 from processing portion 212, in which data 614 is selected images output 612. Alternately, intermediate circuitry may be included between display 208 and processing portion 212 to modify the selected images output 612. Non-limiting examples of intermediate circuitry include matching networks, amplifiers, filters, resistors, etc.

Display 208 then displays images 604, 606, 608 and 610 corresponding to data 614. In the exemplary embodiment, and referring back to FIG. 1, image 604 corresponds to image 102, image 606 corresponds to image 104, image 608 corresponds to image 106 and image 610 corresponds to image 108. Further, the indication data included data 614 is capable of informing the user of the clearest image. In an exemplary embodiment, the indication data highlights image 608 so the user can easily determine that image 608 is the clearest image.

In the embodiments discussed above with reference to FIG. 6, although the user may quickly and easily determine which of images 604, 606, 608 and 610 is the clearest image, the user may still view the remaining images. Accordingly, the user may decide to retain at least one of images 604, 606 and 610, even though such images are not the clearest. Selecting portion 602 enables user to delete any of images 604, 606, 608 and 610. Selecting portion 602 may include any user controllable input system, non-limiting examples of which include buttons or touch-screens, that enables selection of any of images 604, 606, 608 and 610. Once selected, image selector outputs a selection signal 616. Processing portion 212 receives deletion instruction signal 618, which is based on selection signal 616. Processing portion 212 may directly receive selection signal 616 from selecting portion 602, in which deletion instruction signal 618 is selection signal 616. Alternately, intermediate circuitry may be included between processing portion 212 and selecting portion 602 to modify selection signal 616. Non-limiting examples of intermediate circuitry include matching networks, amplifiers, filters, resistors, etc.

Processing portion 212 is operable to effectuate deletion of the selected images from any one of internal memory 214 and memory portion 206 based on deletion instruction signal 618.

In the embodiments discussed above with reference to FIG. 6: image processor 204 processes the data corresponding to a plurality of images; compares the processed data with respect to a predetermined feature; chooses one of the processed data based on the comparison; and sends data to display 208 to display images 604, 606, 608 and 610 with an indication of which image is the clearest. In the exemplary working embodiment; a camera takes a burst of pictures of an object, wherein image sensor 202 obtains a plurality of images; image data corresponding to the plurality of images are sent to image processor 204 for compression with a JPEG compressing method; the compressed image data are stored in internal memory 214; the size of each compressed image data are compared to determine which compressed image data is the largest; once determined, all image data is decompressed and sent to display 208 for display as images 604, 606, 608 and 610, wherein image 408 is highlighted to indicate that image 608 is the clearest image.

In another exemplary embodiment corresponding to FIG. 6, the images may be processed in a parallel manner as described with respect to FIG. 4. For example, processing portion 212 is operable to parallel process data corresponding to all of images 102, 104, 106 and 108 to obtain compressed data for each. With such parallel processing, processing portion 212 is immediately able to determine which compressed data has the largest size. The compressed data having the largest size is then chosen and all of the images are output as selected image output 612 for display as images 604, 606, 608 and 610, wherein image 608 is highlighted to indicate that image 608 is the clearest image. The user may then delete the remaining data corresponding to the remaining images (S412) via selecting portion 602.

FIG. 7 is an oblique view of another exemplary digital camera in accordance with the present invention. In the figure, camera 700 includes a body portion 702, a button 704, a display 208, a select button 706 and a delete button 708. Button 704 enables pictures to be taken in a burst mode of operation. Display 208 displays images 604, 606, 608 and 610, as taken in the burst mode, for the user. Image 608 is additionally highlighted 710 to indicate that image 608 is the clearest image.

In this exemplary digital camera, select button 706 and delete button 708 correspond to image selector 606 of FIG. 6. Selection prompt 712 indicates the image currently selected for deletion. Selection button is operable to move selection prompt 712 among images 604, 606, 608 and 610. Delete button 708 is operable to generate selection signal 616 to instruct at least one of internal memory 214 or memory portion 232 to delete image data corresponding to the image to which selection prompt 712 currently points. With this embodiment, although image 608 is highlighted 710 to indicate that image 608 is the clearest image, the user can view the images 604, 606, 608, and 610 and determine if any of the remaining images should be deleted.

The above discussed embodiments are drawn to determining which, if any, images are to be deleted and the remaining images are to be saved. Other corresponding embodiments would be drawn to the alternative. That is, other embodiments are drawn to determining which, if any, images are to be saved and the remaining images are to be deleted.

The above discussed embodiments are drawn to a detecting device having a processor operable to perform in a specific manner. Other embodiments of the invention are drawn to modification of conventional detecting devices.

An embodiment of the present invention includes a device readable medium, such as a semiconducting memory, that has device readable instructions thereon. The instructions are capable of instructing a device to perform in the manner in accordance with any one of the many embodiments of the present invention. For example, an after-market supplier may provide an upgraded chip for a camera that is capable of instructing the camera to be operable in a burst mode to enable capturing a clearest image in accordance with any one of the many embodiments of the present invention.

Another embodiment of the present invention includes a signal, such as a provided via a cable that has device readable instructions thereon. The instructions are capable of instructing a device to perform in the manner in accordance with any one of the many embodiments of the present invention. For example, a camera may include a data port for upgrading its capabilities. The data port, for example, may be connectable to a remote instruction site. As a specific example the data port may be connected via a Universal Serial Bus (USB) to a computer that is connected via the Internet to a web site. In this example, the web site is capable of instructing the camera to be operable in a burst mode to enable capturing a clearest image in accordance with any one of the many embodiments of the present invention.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device comprising:
an image sensor operable to obtain a first image, to produce first image data based on the first image, to obtain a second image and to produce second image data based on the second image;
an image processor in communication with said image sensor, said image processor being operable to receive a first input data based on the first image data, to receive a second input data based on the second image data, to process the first input data into first processed image data having a first feature, to process the second input data into second processed image data having a second feature, to perform a comparison of the first feature and the second feature, to obtain a result of the comparison and to output at least one of the first processed image data and the second processed image data; and
a memory portion operable to store at least one image memory data based on the outputted at least one of the first processed image data and the second processed image data, respectively.

2. The device of claim 1, wherein said image processor is further operable to process the first input data into the first processed image data using a compression technique based on a spatial frequency transformation and to process the second input data into the second processed image data using the compression technique based on the spatial frequency transformation.

3. The device of claim 2,
wherein the first feature includes an amount of data corresponding to the first processed image data,
wherein the second feature includes an amount of data corresponding to the second processed image data,
wherein said image processor is operable to perform the comparison of the amount of data corresponding to the first processed image data and the amount of data corresponding to the second processed image data,
wherein a result of the comparison includes result data indicating which of the amount of data corresponding to the first processed image data and the amount of data corresponding to the second processed image data is a larger,
wherein said image processor is further operable to delete one of the first processed image data and the second processed image data based the result data,
wherein said image processor is operable to Output the other of the second processed image data and the first processed image data, and
wherein the at least one image memory data comprises one image memory data based on the other of the second processed image data and the first processed image data.

4. The device of claim 3, wherein said image processor comprises an internal memory operable to store the first input data, the second input data, the first processed image data and the second processed image data.

5. The device of claim 2, wherein said image processor comprises an internal memory operable to store the first input data, the second input data, the first processed image data and the second processed image data.

6. The device of claim 2, further comprising a display in communication with said memory portion, said display being operable to display at least one display data based on the at least one of the first image memory data and the second image memory data, respectively.

7. The device of claim 6, further comprising:
a selecting portion,
wherein said display is operable to display a first display data based on the first image memory data and to display a second display data based on the second image memory data,
wherein said selecting portion is operable to perform a selection of one of the first display data and the second display data and to generate a selection signal based on the selection, and
wherein the delete instruction is based on the selection signal.

8. The device of claim 1,
wherein the first feature includes an amount of data corresponding to the first processed image data,
wherein the second feature includes an amount of data corresponding to the second processed image data,
wherein said image processor is operable to perform the comparison of the amount of data corresponding to the first processed image data and the amount of data corresponding to the second processed image data,
wherein a result of the comparison includes result data indicating which of the amount of data corresponding to the first processed image data and the amount of data corresponding to the second processed image data is a larger,
wherein said image processor is further operable to delete one of the first processed image data and the second processed image data based on the result data,
wherein said image processor is operable to output the other of the second processed image data and the first processed image data, and
wherein the at least one image memory data comprises one image memory data based on the other of the second processed image data and the first processed image data.

9. The device of claim 8, further comprising a display in communication with said memory portion, said display being operable to display data based the one image memory data.

10. The device of claim 1,
wherein the first feature includes an amount of data corresponding to the first processed image data,
wherein the second feature includes an amount of data corresponding to the second processed image data,
wherein said image processor is operable to perform the comparison of the amount of data corresponding to the first processed image data and the amount of data corresponding to the second processed image data,
wherein a result of the comparison includes result data indicating which of the amount of data corresponding to the first processed image data and the amount of data corresponding to the second processed image data is a larger,
wherein said image processor is further operable to output the first processed image data and the second processed image data,
wherein said memory portion is further operable to store a first image memory data based the first processed image data and to store a second image memory data based on the second processed image data,
wherein said image processor is further operable generate a delete instruction based on the result, and
wherein said memory portion is further operable to delete one of the first image memory data and the second image memory data based on the delete instruction.

11. The device of claim 10, further comprising a display in communication with said memory portion, said display being operable to display at least one display data based on the at least one of the first image memory data and the second image memory data, respectively.

12. The device of claim 1 further comprising:
a selecting portion,
wherein said display is operable to display a first display data based on the first image memory data and to display a second display data based on the second image memory data,
wherein said selecting portion is operable to perform a selection of one of the first display data and the second display data and to generate a selection signal based on the selection, and
wherein the delete instruction is based on the selection signal.

13. A device readable medium for use with a device comprising an image sensor, an image processor, and a memory portion, the image sensor being operable to obtain a first image, to produce first image data based on the first image, to obtain a second image and to produce second image data based on the second image, the image processor being in communication with the image sensor, the image processor being operable to receive a first input data based on the first image data, to receive a second input data based on the second image data, the device readable medium having device readable instructions stored therein, the device readable instructions being capable of instructing the device to perform the method comprising:
processing, via the image processor, the first input data into first processed image data having a first feature;
processing, via the image processor, the second input data into second processed image data having a second feature;
comparing, via the image processor, the first feature and the second feature;
obtaining, via the image processor, a result of the comparison and to output at least one of the first processed image data and the second processed image data; and
storing, via the memory portion, at least one image memory data based on the outputted at least one of the first processed image data and the second processed image data, respectively.

14. The device readable medium of claim 13,
wherein said processing the first input data into the first processed image data comprises using a compression technique based on a spatial frequency transformation, and
wherein said processing the second input data into the second processed image data comprises using the compression technique based on the spatial frequency transformation.

15. The device readable medium of claim 14, wherein the device readable instructions are capable of instructing the device to perform the method further comprising:
deleting, via the image processor, one of the first processed image data and the second processed image data; and
outputting, via the image processor, the other of the second processed image data and the first processed image data; and
storing, via the memory portion, one image memory data based on the other of the second processed image data and the first processed image data,
wherein the first feature includes an amount of data corresponding to the first processed image data,
wherein the second feature includes an amount of data corresponding to the second processed image data,
wherein said comparing comprises comparing the amount of data corresponding to the first processed image data and the amount of data corresponding to the second processed image data,
wherein said obtaining comprises obtaining result data based on said comparing, the result data indicating which of the amount of data corresponding to the first processed image data and the amount of data corresponding to the second processed image data is a larger, and
wherein said deleting is based on the result data.

16. The device readable medium of claim 13, wherein the device readable instructions are capable of instructing the device to perform the method further comprising:
deleting, via the image processor, one of the first processed image data and the second processed image data; and
outputting, via the image processor, the other of the second processed image data and the first processed image data; and
storing, via the memory portion, one image memory data based on the other of the second processed image data and the first processed image data,
wherein the first feature includes an amount of data corresponding to the first processed image data,
wherein the second feature includes an amount of data corresponding to the second processed image data,
wherein said comparing comprises comparing the amount of data corresponding to the first processed image data and the amount of data corresponding to the second processed image data,
wherein said obtaining comprises obtaining result data based on said comparing, the result data indicating which of the amount of data corresponding to the first processed image data and the amount of data corresponding to the second processed image data is a larger, and
wherein said deleting is based on the result data.

17. The device readable medium of claim 13,
wherein the first feature includes an amount of data corresponding to the first processed image data,
wherein the second feature includes an amount of data corresponding to the second processed image data,
wherein said image processor is operable to perform the comparison of the amount of data corresponding to the first processed image data and the amount of data corresponding to the second processed image data,
wherein the result includes result data indicating which of the amount of data corresponding to the first processed image data and the amount of data corresponding to the second processed image data is a larger,
wherein said image processor is operable to output the of the first processed image data and the second processed image data,
wherein said memory portion is further operable to store a first image memory data based the first processed image data and to store a second image memory data based on the second processed image data,
wherein said image processor is further operable generate a delete instruction based on the result, and
wherein said memory portion is further operable to delete one of the first image memory data and the second image memory data based on the delete instruction.

18. A device readable medium for use with a device comprising an image sensor, an image processor, a memory portion, a display and a selecting portion, the image sensor being operable to obtain a first image, to produce first image data based on the first image, to obtain a second image and to produce second image data based on the second image, the image processor being in communication with the image sensor, the image processor being operable to receive a first input data based on the first image data, to receive a second input data based on the second image data, the display being in communication with the memory portion, the device readable medium having device readable instructions stored therein, the device readable instructions being capable of instructing the device to perform the method comprising:
processing, via the image processor, the first input data into first processed image data having a first feature;
processing, via the image processor, the second input data into second processed image data having a second feature;
comparing, via the image processor, the first feature and the second feature;
obtaining, via the image processor, a result of the comparison and to output at least one of the first processed image data and the second processed image data;
storing, via the memory portion, at least one image memory data based on the outputted at least one of the first processed image data and the second processed image data, respectively, and
displaying, via the display, display data based the at least one image memory data.

19. The device readable medium of claim 18,
wherein the first feature includes an amount of data corresponding to the first processed image data,
wherein the second feature includes an amount of data corresponding to the second processed image data,
wherein said image processor is operable to perform the comparison of the amount of data corresponding to the first processed image data and the amount of data corresponding to the second processed image data,
wherein the result includes result data indicating which of the amount of data corresponding to the first processed image data and the amount of data corresponding to the second processed image data is a larger,
wherein said image processor is operable to output the of the first processed image data and the second processed image data,
wherein said memory portion is further operable to store a first image memory data based the first processed image data and to store a second image memory data based on the second processed image data,
wherein said image processor is further operable generate a delete instruction based oil the result, and
wherein said memory portion is further operable to delete one of the first image memory data and the second image memory data based on the delete instruction.

20. The device readable medium of claim 19, wherein the device readable instructions are capable of instructing the device to perform the method further comprising:
selecting, via the selecting portion, one of the first display data and the second display data; and
generating, via the selecting portion, a selection signal based on said selecting,
wherein said displaying comprises displaying a first display data based on the first image memory data and displaying a second display data based on the second image memory data, and
wherein the deletion instruction is based on the selection signal.
